(19) United States
(12) Patent Application Publication
(10) Pub. No.: US 2025/0319865 A1
(43) Pub. Date: Oct. 16, 2025

(54) Method and Apparatus for Controlling Vehicle to Avoid Collision with Obstacle

(71) Applicants: Hyundai Motor Company, Seoul (KR); Kia Corporation, Seoul (KR)

(72) Inventors: Joon Ho Lee, Seoul (KR); Sang Min Lee, Seoul (KR); Eung Seo Kim, Gwacheon-Si (KR); Yong Seok Kwon, Suwon (KR)

(21) Appl. No.: 18/968,414

(22) Filed: Dec. 4, 2024

(30) Foreign Application Priority Data
Apr. 12, 2024 (KR) 10-2024-0049237

(51) Int. Cl. B60W 30/09; B60W 10/18; B60W 10/20; B60W 30/095

(52) U.S. Cl. CPC B60W 30/09; B60W 10/18; B60W 10/20; B60W 30/0956; B60W 2554/4041; B60W 2554/801

(57) ABSTRACT

A method and an apparatus for controlling vehicle to avoid collision with obstacle are disclosed. A method may include identifying, via one or more sensors, a plurality of objects around a vehicle, determining, among the plurality of identified objects and based on a distance between the vehicle and each of the plurality of identified objects, a plurality of target objects that are at risk of colliding with the vehicle, determining, based on classifying a location of each of the plurality of target objects into one of a plurality of subregions within a driving lane of the vehicle, a vehicle control path for the vehicle, and controlling, based on the vehicle control path, the vehicle to avoid colliding with the plurality of target objects.

### CROSS-REFERENCE TO RELATED APPLICATION

This application claims priority to Korean Patent Application No. 10-2024-0049237, filed on Apr. 12, 2024 in the Korea Intellectual Property Office, the entire contents of which are incorporated herein by reference.

### TECHNICAL FIELD

The present disclosure relates to a method and an apparatus for controlling a vehicle to avoid a collision with an obstacle.

### BACKGROUND

The content described below simply provides background information related to the present embodiment and does not constitute prior art.

A forward collision-avoidance assist (FCA) system may estimate or recognize a distance to a preceding vehicle or pedestrian using a distance detection sensor to warn of a risk of a collision and/or control a vehicle. In situations in which there is a risk of a collision, if a user presses a brake pedal hard, the FCA system may control the vehicle with a maximum braking force.

When multiple obstacles are present in a traffic lane, the FCA system of at least some implementations may control the vehicle by independently determining a risk of a collision for each obstacle. In such a case, a problem may arise when discontinuous control of the vehicle may occur or, in the process of attempting to avoid a collision with one object, a secondary collision may occur with one or more of the remaining obstacles.

In addition, since some implementations of the FCA system determines a brake control timing of the vehicle using only collision overlap between obstacles and the vehicle, a collision may occur when there are multiple obstacles with small collision overlap.

### SUMMARY

The present disclosure provides a method and an apparatus for controlling a vehicle to avoid a collision with an obstacle.

The present disclosure also provides a method and an apparatus for avoiding a collision by advancing a brake control timing when a route of a vehicle is blocked.

The present disclosure also provides a method and an apparatus for avoiding a collision by advancing a brake control timing when it is impossible to avoid a collision using steering of a vehicle although a route of the vehicle is not blocked.

The problems to be solved by the present disclosure are not limited to the problems mentioned above, and other problems not mentioned may be clearly understood by those skilled in the art from the description below.

According to one or more example embodiments of the present disclosure, a method performed by an apparatus of a vehicle may include: identifying, via one or more sensors, a plurality of objects around the vehicle; determining, among the plurality of identified objects and based on a distance between the vehicle and each of the plurality of identified objects, a plurality of target objects that are at risk of colliding with the vehicle; determining, based on classifying a location of each of the plurality of target objects into one of a plurality of subregions within a driving lane of the vehicle, a vehicle control path for the vehicle; and controlling, based on the vehicle control path, the vehicle to avoid colliding with the plurality of target objects.

The plurality of subregions may include at least a left subregion, a right subregion, and a center subregion.

Classifying the location of each of the plurality of target objects may include at least one of: determining, based on a distance between a left line of the driving lane and a target object, of the plurality of target objects, being less than a width of the left subregion, that the target object is present in the left subregion; determining, based on a distance between a right line of the driving lane and the target object being less than a width of the right subregion, that the target object is present in the right subregion; or determining, based on the distance between the left line of the driving lane and the target object being greater than the width of the left subregion and based on the distance between the right line of the driving lane and the target object being greater than the width of the right subregion, that the target object is present in the center subregion.

Controlling the vehicle may include: based on at least one of the plurality of target objects being present in the center subregion, moving a brake control timing of the vehicle from a first time to a second time that is earlier than the first time.

Controlling the vehicle may include: based on none of the plurality of target objects being present in the center subregion and at least some of the plurality of target objects being present in the left subregion and in the right subregion, controlling steering of the vehicle to avoid colliding with the plurality of target objects.

Controlling the vehicle may further include moving a brake control timing of the vehicle from a first time to a second time that is earlier than the first time.

Controlling the vehicle may further include operating a steering function of the vehicle.

Controlling the vehicle may include: based on none of the plurality of target objects being present in the center subregion and at least one of the plurality of target objects being present in one of the left subregion or the right subregion, operating a braking function of the vehicle.

The method may further include: determining, among the plurality of identified objects, a single target object that is at risk of colliding with the vehicle; and based on the determining the single target object, controlling of the vehicle to operate a braking function of the vehicle.

Controlling the vehicle may include: determining, based on none of the plurality of target objects being present in the center subregion and at least some of the plurality of target objects being present in the left subregion and in the right subregion, and further based on a distance between the plurality of target objects being less than a threshold distance, that it is impossible to avoid colliding with at least one of the plurality of target objects and controlling the vehicle to perform braking.

The threshold distance may be determined based on performance of the vehicle.

The threshold distance may include a longitudinal threshold distance. The longitudinal threshold distance (ThresholdLong) may be determined based on an equation of

$${Threshold}_{Long} = \sqrt{\frac{2 {W}_{E}}{{a}_{lat}}} \times {V}_{E} ,$$

and wherein WE is a width of the vehicle, aₗₐₜ is a lateral acceleration of the vehicle, and V_{E} is a current speed of the vehicle.

According to one or more example embodiments of the present disclosure, an apparatus may include: memory storing instructions; and at least one processor. The at least one processor may be configured to execute the instructions to cause the apparatus to: identify, via one or more sensors, a plurality of objects around a vehicle; determine, among the plurality of identified objects and based on a distance between the vehicle and each of the plurality of identified objects, a plurality of target objects that are at risk of colliding with the vehicle; determine, based on classifying a location of each of the plurality of target objects into one of a plurality of subregions within a driving lane of the vehicle, a vehicle control path for the vehicle; and control, based on the vehicle control path, the vehicle to avoid colliding with the plurality of target objects.

The plurality of subregions may include at least a left subregion, a right subregion, and a center subregion.

The at least one processor may be configured to execute the instructions to control the vehicle by: based on at least one of the plurality of target objects being present in the center subregion, moving a brake control timing of the vehicle from a first time to a second time that is earlier than the first time.

The at least one processor may be configured to execute the instructions to control the vehicle by: based on none of the plurality of target objects being present in the center subregion and at least some of the plurality of target objects being present in the left subregion and in the right subregion, controlling steering of the vehicle to avoid colliding with the plurality of target objects.

The at least one processor may be configured to execute the instructions to control the vehicle by: based on none of the plurality of target objects being present in the center subregion and at least one of the plurality of target objects being present in one of the left subregion or the right subregion, operating a braking function of the vehicle.

According to one or more example embodiments of the present disclosure, a computer-readable storage medium may store instructions that, when executed by at least one processor, cause: identifying, via one or more sensors, a plurality of objects around a vehicle;
determining, among the plurality of identified objects and based on a distance between the vehicle and each of the plurality of identified objects, a plurality of target objects that are at risk of colliding with the vehicle; determining, based on classifying a location of each of the plurality of target objects into one of a plurality of subregions within a driving lane of the vehicle, a vehicle control path for the vehicle; and controlling, based on the vehicle control path, the vehicle to avoid colliding with the plurality of target objects.

The plurality of subregions may include at least a left subregion, a right subregion, and a center subregion.

The instructions, when executed by at least one processor, may cause the classifying of the location by at least one of: determining, based on a distance between a left line of the driving lane and a target object, of the plurality of target objects, being less than a width of the left subregion, that the target object is present in the left subregion; determining, based on a distance between a right line of the driving lane and the target object being less than a width of the right subregion, that the target object is present in the right subregion; or determining, based on the distance between the left line of the driving lane and the target object being greater than the width of the left subregion and based on the distance between the right line of the driving lane and the target object being greater than the width of the right subregion, that the target object is present in the center subregion.

According to an embodiment of the present disclosure, when a plurality of obstacles exist in front of a vehicle, the vehicle is controlled by comprehensively utilizing information on the plurality of obstacles, thereby improving safety.

According to an embodiment of the present disclosure, when to control a vehicle may be determined by determining whether a lane is blocked.

According to an embodiment of the present disclosure, an optimal control point for preventing an accident may be determined by determining a possibility of avoiding a collision between an obstacle and the vehicle using the vehicle steering.

The effects of the present disclosure are not limited to the effects mentioned above, and other effects not mentioned may be clearly understood by those skilled in the art from the description below.

### BRIEF DESCRIPTION OF THE DRAWINGS

FIG. 1 is a block diagram schematically illustrating a collision avoidance device according to an embodiment of the present disclosure.

FIG. 2 is a diagram illustrating a process of selecting a target with a risk of collision by a collision avoidance device according to an embodiment of the present disclosure.

FIG. 3 is a diagram illustrating a process in which a collision avoidance device sets a target presence region according to an embodiment of the present disclosure.

FIG. 4 is a diagram illustrating a process of determining whether a collision avoidance device is able to avoid a collision using vehicle steering according to an embodiment of the present disclosure.

FIG. 5 is a flowchart schematically illustrating an operation of a collision avoidance device according to an embodiment of the present disclosure.

FIGS. 6A, 6B, and 6C are diagrams illustrating an operation of a collision avoidance device according to an embodiment of the present disclosure.

FIG. 7 is a flowchart illustrating a collision avoidance method according to an embodiment of the present disclosure.

FIG. 8 is a block diagram schematically illustrating a computing device that may be used to implement a method according to the present disclosure.

### DETAILED DESCRIPTION

Hereinafter, embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Additionally, various terms such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is intended to further include other components and not intended to exclude other components unless specifically stated to the contrary. The terms such as ‘unit’, ‘module’, and the like refer to one or more units for processing at least one function or operation, which may be implemented by hardware, software, or a combination thereof. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

The following detailed description, together with the accompanying drawings, is intended to illustrate embodiments of the present disclosure and is not intended to represent the only embodiments in which the disclosure may be practiced.

Hereinafter, ‘a plurality of’ targets refer to a situation in which there are two or more targets. A target may also be referred to as an object or an obstacle. A target may be stationary or in motion.

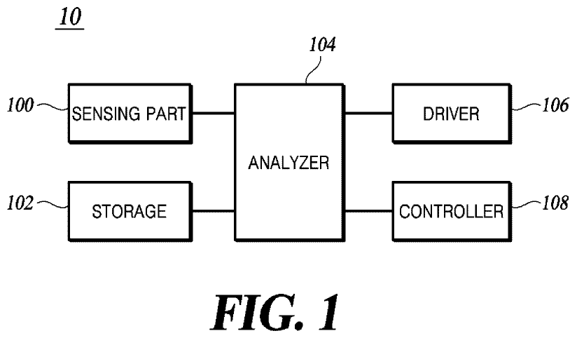

FIG. 1 is a block diagram schematically illustrating a collision avoidance device according to an embodiment of the present disclosure.

A collision avoidance device 10 according to an embodiment of the present disclosure may include all or some of a sensing part 100, a storage 102, an analyzer 104, a driver 106, and a controller 108. Not all blocks shown in FIG. 1 are essential components of the collision avoidance device 10, and in other embodiments, some blocks included in the collision avoidance device 10 may be added, changed, or deleted. Meanwhile, the components shown in FIG. 1 represent functionally distinct elements, and at least one component may be implemented in an integrated form in an actual physical environment.

The sensing part 100 may detect a preceding vehicle (also referred to as a leading vehicle, a lead vehicle, a vehicle in front, a vehicle ahead, etc.), lines, lanes, road facilities, pedestrians, and other objects (e.g., obstacles, targets, etc.) around a vehicle. The sensing part 100 may be a camera, a lidar sensor, a radar sensor, and an infrared sensor or may be a combination of two or more of a camera, a lidar sensor, a radar sensor, and an infrared sensor. The sensing part 100 is not particularly limited as long as it may detect a preceding vehicle, a line, a lane, road structures, a pedestrian, etc. around the vehicle.

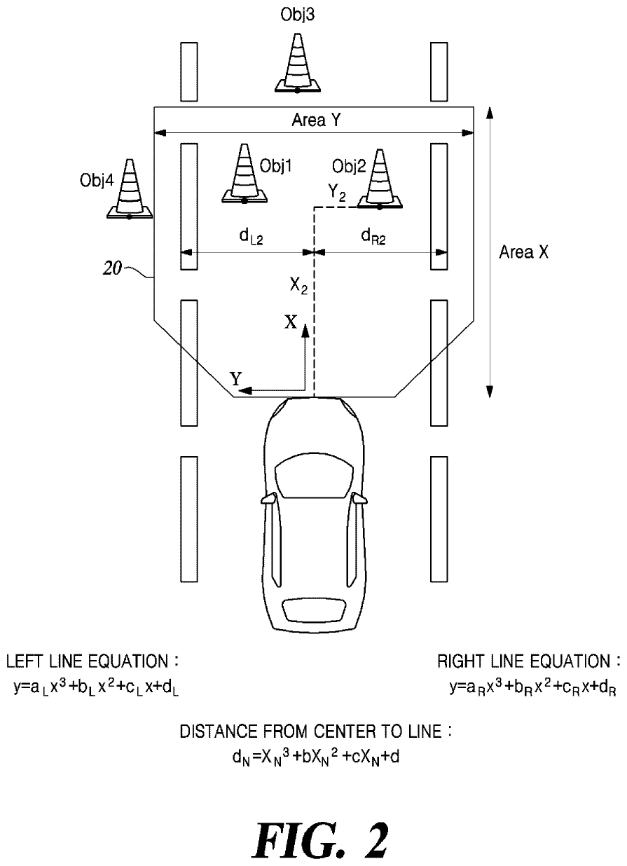

The analyzer 104 selects a target that is at risk of a collision with a vehicle among the targets detected by the sensing part 100. A target within a dangerous region (also referred to as a collision risk zone) is selected as a target that is at risk of a collision with the vehicle. The dangerous region may be set to vary depending on the performance of the vehicle. For example, Obj1 and Obj2 inside a dangerous region 20 of FIG. 2 are targets with a risk of a collision, and Obj3 and Obj4 outside the dangerous region 20 are not targets with a risk of a collision.

The analyzer 104 determines whether there are multiple targets inside a lane. It is determined whether a detected object ObjN exists within the lane. If there are two or more targets within the lane, it is determined that there are multiple targets. For example, Obj1 and Obj2 in FIG. 2 are multiple targets that exist within the lane.

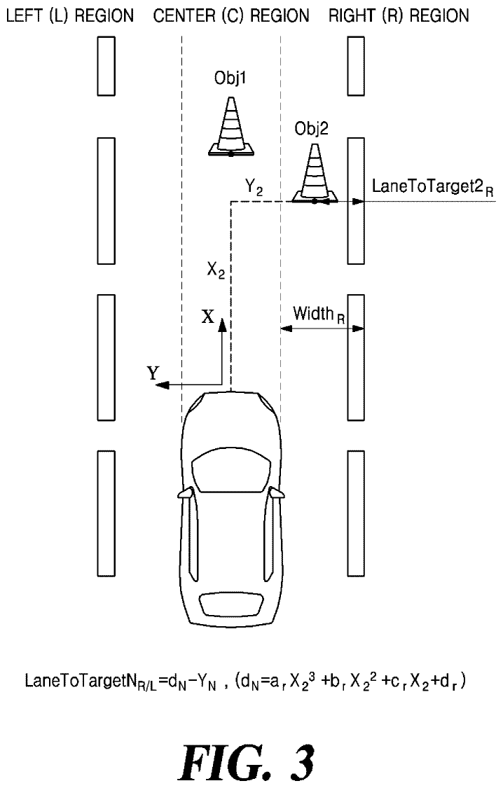

The analyzer 104 determines whether the target exists in the left, right, or center region based on the vehicle using lane information. For example, Obj1 in FIG. 3 is determined to be a target existing in the center region, and Obj2 is determined to be a target existing in the right region.

The analyzer 104 classifies the situation based on the region in which multiple targets exist and sets a vehicle control method (e.g., a vehicle control route).

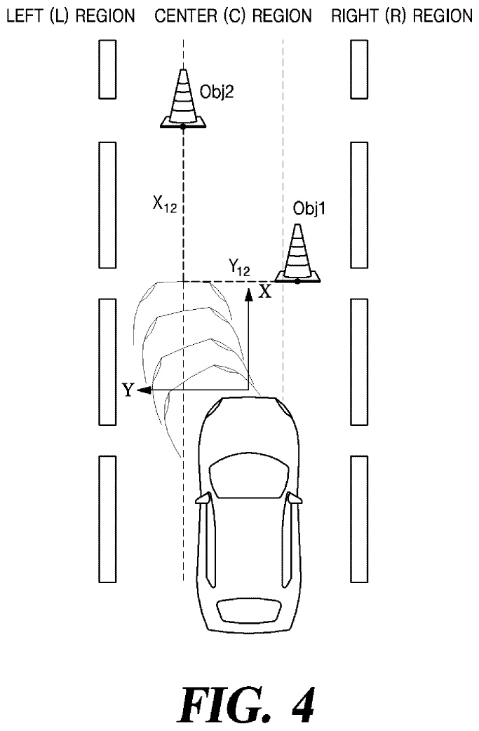

FIG. 4 is a diagram illustrating a process of determining whether a collision avoidance device according to an embodiment of the present disclosure may avoid a collision using vehicle steering.

The analyzer 104 determines whether a collision between the vehicle and the target may be avoided using steering based on a distance between a plurality of targets. If the distance between the plurality of targets is less than a threshold distance, the analyzer 104 may determine that a collision between the vehicle and the target cannot be avoided using steering. The analyzer 104 may determine that a collision between the vehicle and the target may be avoided using steering when the distance between the plurality of targets is greater than or equal to the threshold distance. The threshold distance may change depending on the performance of the vehicle. For example, referring to FIG. 4, in a situation where the targets ObjN are Obj1 and Obj2, if a longitudinal distance X12 between the two targets is less than ThresholdLong and a lateral distance Y₁₂ between the two targets is less than Threshold_{Lat}, the analyzer 104 may determine that a collision between the vehicle and the targets cannot be avoided through vehicle steering (X₁₂<Threshold_{Long} and Y₁₂<Threshold_{Lat}).

Threshold_{Long} is a limit longitudinal distance that may be avoided through steering and may be calculated based on a limit situation. The limit situation is a situation in which, after a first obstacle has been avoided using steering, a second obstacle is located at the border between the left region and the center region or the border between the right region and the center region. Specifically, if the vehicle's lateral movement distance for avoiding the second obstacle is 0.5W_{E} (W_{E} is a vehicle width), Threshold_{Long} may be calculated using Equation 1.

$${Threshold}_{Long} = \sqrt{\frac{2 {W}_{E}}{{a}_{lat}}} \times {V}_{E} \qquad [ Equation 1 ]$$

aₗₐₜ is a lateral acceleration of the vehicle based on the assumption of constant acceleration during steering avoidance, and V_{E} is a current speed of the vehicle.

Threshold_{Lat} is a limit lateral distance that may be avoided through steering and may be calculated using Equation 2.

$${Threshold}_{Lat} = {W}_{E} + α , \{ α = f ( {V}_{Ego} ) \} \qquad [ Equation 2 ]$$

α is a margin, and f is a function that changes depending on the vehicle speed.

The storage 102 stores programs and information necessary for controlling the functions of the FCA system. The storage 102 may store information sensed by the sensing part 100 and information generated by the analyzer 104.

The driver 106 includes a steering device, a braking device, or an acceleration device to control the vehicle. The driver 106 may control a direction or speed of the vehicle under the control of the controller 108.

The controller 108 may control the vehicle by controlling other components. For example, the controller 108 may perform a function of at least one or more of engine management system (EMS), electronic stability control (ESC), electronic stability program (ESP), vehicle dynamic control (VDC), lane keeping assistance system (LKAS), smart cruise control (SCC), adaptive cruise control (ACC), autonomous emergency braking (AEB), forward collision-avoidance assist (FCA), highway driving assist (HDA), highway driving pilot (HDP), lane departure warning (LDP), driver awareness warning (DAW), or driver state warning (DSW). These functions are collectively called an advanced driver assist system (ADAS).

The controller 108 operates a basic braking function when there is only one target inside a lane. If there are multiple targets within the lane and the lane is blocked, a brake control timing is advanced (e.g., expedited or moved to an earlier time). If there are multiple targets within the lane and collision avoidance is possible using steering, a basic steering function is activated. If there are multiple targets within the lane and collision avoidance using steering is not possible, the brake control timing is advanced (e.g., expedited or moved to an earlier time). If there are multiple targets within the lane and the targets exist only in either the left or right region, the basic braking function is activated. Here, ‘advancing’ refers to advancing the timing.

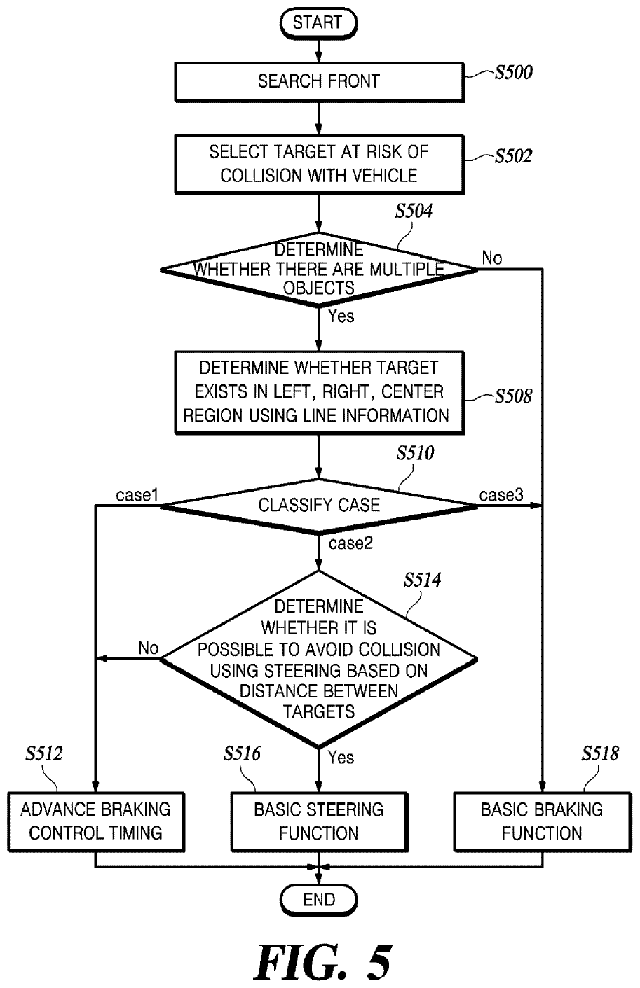

FIG. 5 is a flowchart schematically illustrating an operation of a collision avoidance device according to an embodiment of the present disclosure.

The collision avoidance device 10 searches the front of the vehicle and detects a preceding vehicle, a line, a lane, road facilities, and a pedestrian (S500).

FIG. 2 is a diagram illustrating a process of selecting a target with a risk of a collision by a collision avoidance device according to an embodiment of the present disclosure.

The collision avoidance device 10 selects a target that is at risk of a collision with a vehicle from among the detected targets (S502). Specifically, referring to FIG. 2, a longitudinal distance X_{N} from the vehicle to a detection target is shorter than a longitudinal distance AreaX in a dangerous region and a lateral distance Y_{N} from the vehicle to the detection target is shorter than a lateral distance AreaY of the dangerous region, the detected target may be selected as a target with a risk of a collision with the vehicle (X_{N}<Area X and Y_{N}<Area Y).Here, the lateral distance of the dangerous region may be expressed as Area Y=f(X_{N}) using a variable function f(x).

The collision avoidance device 10 determines whether there are multiple targets within the lane (S504). Specifically, referring to FIG. 2, when the lateral distance Y_{N} from the vehicle to the target is shorter than a distance d_{RN} from the center of the lane to a right line and the lateral distance Y_{N} from the vehicle to the target is shorter than a distance d_{LN} from the center of the lane to a left line, the target may be set to exist within the lane (Y_{N}<d_{RN} and Y_{N}<d_{LN}). If there are two or more targets within the lane, it is determined that multiple targets exist.

When there is only one target within the lane, the collision avoidance device 10 operates the basic braking function to avoid a collision (S518).

FIG. 3 is a diagram illustrating a process in which a collision avoidance device sets a target presence region according to an embodiment of the present disclosure.

When there are multiple targets within the lane, the collision avoidance device 10 determines the target presence region (also referred to as a subregion) using lane information (S508). Specifically, referring to FIG. 3, when a distance (LaneToTargetN_{R/L}) from the left or right line to the target is less than a region width Width_{R/L}, it is determined that the target exists in the left region (also referred to as the left subregion) or the right region (also referred to as the right subregion) of the lane (LaneToTargetN_{R/L}<Width_{R/L} and LaneToTargetN_{R/L}>0). If the distance from the left and right lines to the target is greater than or equal to the region width, it is determined that the target exists in the center region (also referred to as the center subregion) of the lane (LaneToTargetN_{R}≥Width_{R} and LaneToTargetN_{L}≥Width_{L}). At this time, Width, represents a distance from the left line of the lane to the boundary between the left region and the center region, and Width_{R} represents a distance from the right line of the lane to the boundary between the right region and the center region.

The collision avoidance device 10 classifies the situation based on the regions in which multiple targets exist (S510). Table 1 illustrates situation classification criteria for each region in which targets exist.

TABLE 1

| if C == 1 | L == 1 | L == 0 |
|---|---|---|
| R == 1 | CASE1 | CASE1 |
| R == 0 | CASE1 | CASE1 |
| if C == 0 | L == 1 | L == 0 |
| R == 1 | CASE2 | CASE3 |
| R == 0 | CASE3 | — |

Referring to Table 1, a case in which one or more targets are determined to exist in the center region of the lane among the plurality of targets (C==1), the lane is blocked, which is classified as CASE1. A case in which, among multiple targets, target is determined not to exist in the center region of the lane (C==0) and a case in which one or more targets are determined to exist in both left and right regions of the lane (R==1 and L==1) are cases in which whether the vehicle is able to avoid a collision with the targets using vehicle steering is to be determined, which are classified as CASE2. Other cases are cases in which multiple targets are determined to exist in a single region, which is classified as CASE3.

In CASE1, the collision avoidance device 10 advances (e.g., expedites or moves to an earlier time) the vehicle's brake control timing to avoid a collision between the vehicle and the target (S512).

In CASE2, the collision avoidance device 10 determines whether a collision between the vehicle and the target may be avoided using vehicle steering based on the distance between the plurality of targets (S514). If collision avoidance is possible using steering, the basic steering function is operated to avoid a collision between the vehicle and the target (S516). If collision avoidance using steering is not possible, the vehicle's brake control timing is advanced (e.g., expedited or moved to an earlier time) to avoid a collision between the vehicle and the target.

In CASE3, the collision avoidance device 10 operates the basic braking function (S518).

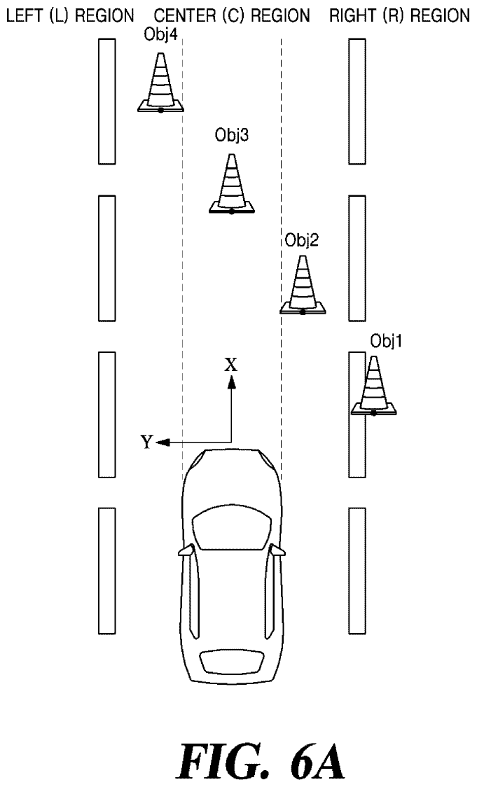

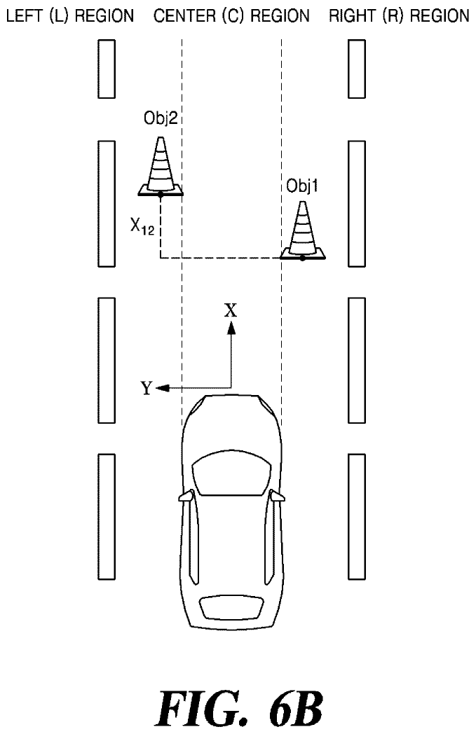

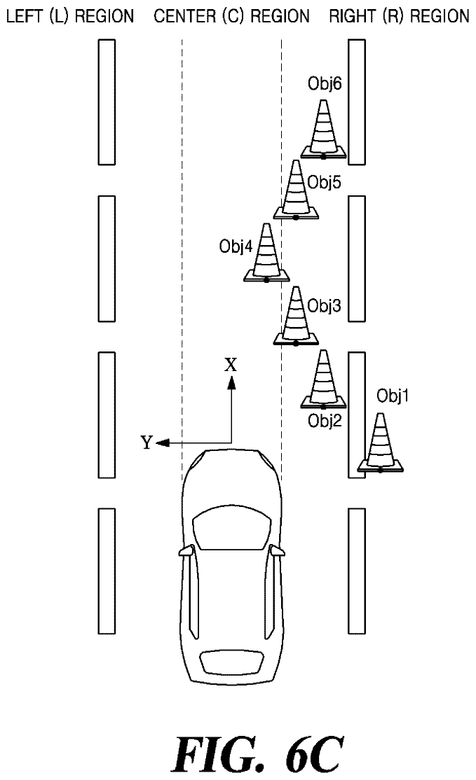

FIGS. 6A, 6B, and 6C are diagrams illustrating an operation of a collision avoidance device according to an embodiment of the present disclosure.

For example, referring to FIG. 6A, the collision avoidance device 10 searches the front of the vehicle and detects Obj1, Obj2, Obj3, and Obj4. Among them, Obj2, Obj3, and Obj4 are selected as targets that exist inside the vehicle's lane. Using line information, Obj2 is selected as a target existing in the right region based on the vehicle, Obj3 is selected as a target existing in the center region, and Obj4 is selected as a target existing in the left region. Since the target exists in the center region, the lane is blocked, and the vehicle's brake control timing is advanced (e.g., expedited or moved to an earlier time) to avoid a collision between Obj2 and the vehicle.

As another example, referring to FIG. 6B, the collision avoidance device 10 searches the front of the vehicle and selects Obj1 and Obj2 as targets existing within the lane. Using line information, Obj1 is selected as a target existing in the right region based on the vehicle, and Obj2 is selected as a target existing in the left region. Since there is no target in the center region and targets exist in the left and right regions, it is determined whether a collision between the vehicle and the target may be avoided using steering. In the case of X₁₂<Threshold_{Long}, the vehicle's brake control timing is advanced (e.g., expedited or moved to an earlier time) to avoid a collision between Obj1 and the vehicle. In the case of X₁₂≥Threshold_{Long}, the basic steering function is operated to avoid a collision between the vehicle and the target.

As another example, referring to FIG. 6C, the collision avoidance device 10 searches the front of the vehicle and selects Obj2, Obj3, Obj4, Obj5, and Obj6 as targets existing within the lane. Using line information, Obj2, Obj3, Obj5, and Obj6 are selected as targets located in the right region based on the vehicle, and Obj4 is selected as a target located in the center region. Since the target exists in the center region, the lane is blocked, and the vehicle's brake control timing is advanced (e.g., expedited or moved to an earlier time) to avoid a collision between Obj3 and the vehicle.

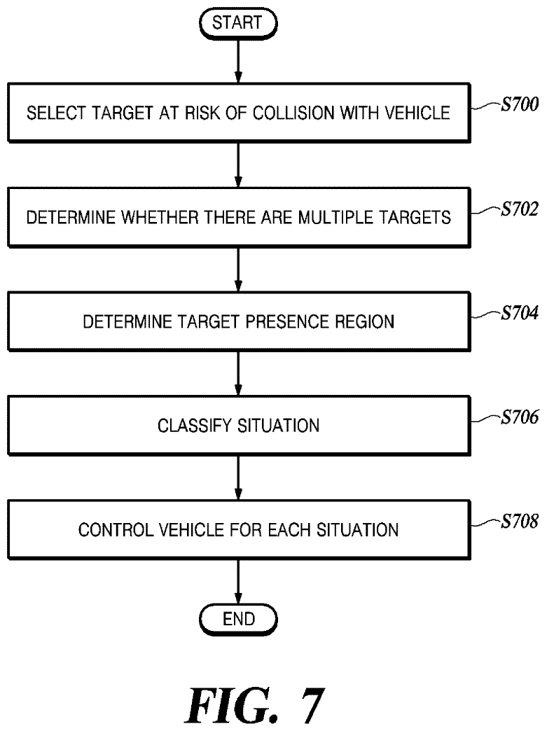

FIG. 7 is a flowchart illustrating a collision avoidance method according to an embodiment of the present disclosure. The method shown in FIG. 7 may be executed by a collision avoidance system including one or more physical computing devices to be implemented. The following description is given in terms of the operation performed by the collision avoidance system.

The collision avoidance system searches the front of the vehicle to detect a preceding vehicle, a line, a lane, road facilities, and a pedestrian, and selects a target that is at risk of a collision with the vehicle among the detected targets (S700). Specifically, if the detected target exists inside a dangerous region, the target may be selected as a target with a risk of a collision.

The collision avoidance system determines whether there are multiple targets within the lane (S702). If a lateral distance from the vehicle to the target is shorter than a distance from the center of the lane to the right line and a lateral distance from the vehicle to the target is shorter than a distance from the center of the lane to the left line, the target may be set to be within the lane. If there are two or more targets within the lane, it is determined that there are multiple targets. If there is only one target within the lane, the basic braking function may be activated.

The collision avoidance system determines the target presence region using line information (S704). Specifically, when the distance LaneToTargetN_{R/L}—from the left or right line to the target is less than the region width Width_{R/L}, it is determined that the target exists in the left or right region of the lane (LaneToTargetN_{R/L}<Width_{R/L} and LaneToTargetN_{R/L}>0). If the distance from the left and right lines to the target is greater than or equal to the Threshold, it is determined that the target exists in the center region of the lane (LaneToTargetN_{R}≥Width_{R} and LaneToTargetN_{L}≥Width_{L}).

The collision avoidance system classifies the situation based on the target presence region (S706). a case in which one or more targets are determined to exist in the center region of the lane among the plurality of targets, the lane is blocked, which is classified as CASE1. A case in which, among multiple targets, target is determined not to exist in the center region of the lane and a case in which one or more targets are determined to exist in both left and right regions of the lane are cases in which whether the vehicle is able to avoid a collision with the targets using vehicle steering is to be determined, which are classified as CASE2. Other cases are cases in which multiple targets are determined to exist in a single region, which is classified as CASE3.

The collision avoidance system controls the vehicle to prevent a collision (S708). The collision avoidance system may determine a vehicle control path based on the classifications (e.g., CASE1, CASE2, or CASE3). The determined control path may include a planned route and/or a brake control timing. In CASE1, the collision avoidance system advances the vehicle's brake control timing (e.g., activates brake control sooner) to avoid a collision between the vehicle and the target. In other words, in CASE 1, the collision avoidance system may move the vehicle's brake control timing from a first time to a second time that is earlier than the first time. In CASE2, the collision avoidance system determines whether a collision between the vehicle and the target may be avoided using vehicle steering based on the distance between the plurality of targets. If collision avoidance is possible using steering, the basic steering function is operated to avoid a collision between the vehicle and the target. If collision avoidance using steering is not possible, the vehicle's brake control timing is advanced (e.g., expedited or moved to an earlier time) to avoid a collision between the vehicle and the target. In CASE3, the collision avoidance system operates the basic braking function.

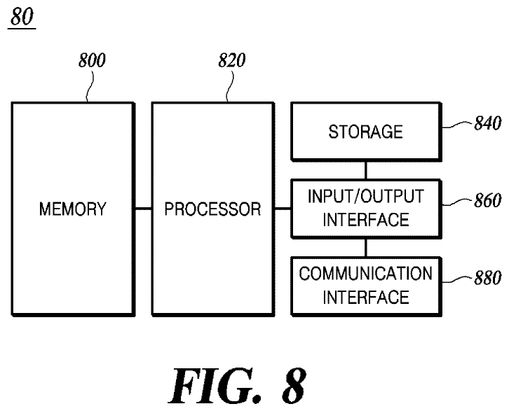

FIG. 8 is a block diagram schematically illustrating a computing device that may be used to implement a method according to the present disclosure.

A computing device 80 may include some or all of a memory 800, a processor 820, a storage 840, an input/output interface 860, and a communication interface 880. The computing device 80 may structurally and/or functionally include at least a portion of the collision avoidance device 10. The computing device 80 may be a stationary computing device, such as a desktop computer, a server, an AI accelerator, etc., as well as a portable computing device, such as a laptop computer, a smartphone, etc.

The memory 800 may store programs that enable the processor 820 to perform methods or operations according to various embodiments of the present disclosure. For example, the program may include a plurality of instructions executable by the processor 820, and the method shown in FIG. 7 may be performed by executing the plurality of instructions by the processor 820.

The memory 800 may be a single memory or multiple memories. In this case, information required to perform the methods or operations according to various embodiments of the present disclosure may be stored in a single memory or divided to be stored in a plurality of memories. When the memory 800 is configured as a plurality of memories, the plurality of memories may be physically separated.

The memory 800 may include at least one of volatile memory and non-volatile memory. Volatile memory includes static random access memory (SRAM) or dynamic random access memory (DRAM), and non-volatile memory includes flash memory.

The processor 820 may include at least one core capable of executing at least one instruction. The processor 820 may execute instructions stored in the memory 800. The processor 820 may be a single processor or multiple processors.

The storage 840 maintains stored data even when power supplied to computing device 80 is cut off. For example, the storage 840 may include non-volatile memory or a storage medium, such as magnetic tape, optical disk, or magnetic disk.

A program stored in the storage 840 may be loaded to the memory 800 before being executed by the processor 820. The storage 840 may store files written in a program language, and a program created from a file by a compiler, etc. may be loaded to the memory 800. The storage 840 may store data to be processed by the processor 820 and/or data processed by the processor 820.

The input/output interface 860 may include an input device, such as a keyboard or mouse, and may include an output device, such as a display device or printer. The user may trigger execution of a program by the processor 820 and/or check processing results of the processor 820 through the input/output interface.

The communication interface 880 may provide access to external networks. For example, the computing device 80 may communicate with other devices through the communication interface 880.

Each element of the apparatus or method in accordance with the present disclosure may be implemented in hardware, software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

According to an embodiment, the present disclosure provides a collision avoidance method, the method comprising: detecting objects around a vehicle; setting a collision dangerous region; selecting a target that is at risk of a collision with the vehicle from among the detected objects; determining whether there are two or more targets within a lane of the vehicle; classifying vehicle control methods for two or more targets based on a target presence region; and controlling the vehicle to avoid a collision between the vehicle and the target.

According to another embodiment, the present disclosure provides an apparatus, the apparatus comprising: at least one memory storing instructions; and at least one processor, wherein the at least one processor executes the instructions to detect objects around a vehicle, set a collision dangerous region, select a target that is at risk of a collision with the vehicle among the detected objects, determine whether there are two or more targets within a lane of the vehicle, classify vehicle control methods for two or more targets based on a target presence region, and control the vehicle to avoid a collision between the vehicle and the target.

Although operations are illustrated in the flowcharts/timing charts in this specification as being sequentially performed, this is merely a description of the technical idea of one embodiment of the present disclosure. In other words, those having ordinary skill in the art to which one embodiment of the present disclosure belongs may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those ordinary skill in the art should appreciate that various modifications, additions, and substitutions are possible, without departing from the idea and scope of the claims. Therefore, embodiments of the present disclosure have been described for the sake of brevity and clarity. The scope of the technical idea of the present embodiments is not limited by the illustrations. Accordingly, one of ordinary skill should understand that the scope of the present disclosure should not be limited by the above explicitly described embodiments but by the claims and equivalents thereof.

What is claimed is:

1. A method performed by an apparatus of a vehicle, the method comprising:
identifying, via one or more sensors, a plurality of objects around the vehicle;
determining, among the plurality of identified objects and based on a distance between the vehicle and each of the plurality of identified objects, a plurality of target objects that are at risk of colliding with the vehicle;
determining, based on classifying a location of each of the plurality of target objects into one of a plurality of subregions within a driving lane of the vehicle, a vehicle control path for the vehicle; and
controlling, based on the vehicle control path, the vehicle to avoid colliding with the plurality of target objects.

2. The method of claim 1, wherein the plurality of subregions comprise at least a left subregion, a right subregion, and a center subregion.

3. The method of claim 2, wherein the classifying of the location of each of the plurality of target objects comprises at least one of:
determining, based on a distance between a left line of the driving lane and a target object, of the plurality of target objects, being less than a width of the left subregion, that the target object is present in the left subregion;
determining, based on a distance between a right line of the driving lane and the target object being less than a width of the right subregion, that the target object is present in the right subregion; or
determining, based on the distance between the left line of the driving lane and the target object being greater than the width of the left subregion and based on the distance between the right line of the driving lane and the target object being greater than the width of the right subregion, that the target object is present in the center subregion.

4. The method of claim 2, wherein the controlling of the vehicle comprises:
based on at least one of the plurality of target objects being present in the center subregion, moving a brake control timing of the vehicle from a first time to a second time that is earlier than the first time.

5. The method of claim 2, wherein the controlling of the vehicle comprises:
based on none of the plurality of target objects being present in the center subregion and at least some of the plurality of target objects being present in the left subregion and in the right subregion, controlling steering of the vehicle to avoid colliding with the plurality of target objects.

6. The method of claim 5, wherein the controlling of the vehicle further comprises moving a brake control timing of the vehicle from a first time to a second time that is earlier than the first time.

7. The method of claim 5, wherein the controlling of the vehicle further comprises operating a steering function of the vehicle.

8. The method of claim 2, wherein the controlling of the vehicle comprises:
based on none of the plurality of target objects being present in the center subregion and at least one of the plurality of target objects being present in one of the left subregion or the right subregion, operating a braking function of the vehicle.

9. The method of claim 1, further comprising:
determining, among the plurality of identified objects, a single target object that is at risk of colliding with the vehicle; and
based on the determining the single target object, controlling of the vehicle to operate a braking function of the vehicle.

10. The method of claim 2, wherein the controlling of the vehicle comprises:
determining, based on none of the plurality of target objects being present in the center subregion and at least some of the plurality of target objects being present in the left subregion and in the right subregion, and further based on a distance between the plurality of target objects being less than a threshold distance, that it is impossible to avoid colliding with at least one of the plurality of target objects and controlling the vehicle to perform braking.

11. The method of claim 10, wherein the threshold distance is determined based on performance of the vehicle.

12. The method of claim 10, wherein the threshold distance comprises a longitudinal threshold distance, wherein the longitudinal threshold distance (Threshold_{Long}) is determined based on an equation of
$${Threshold}_{Long} = \sqrt{\frac{2 {W}_{E}}{{a}_{lat}}} \times {V}_{E} ,$$
and wherein W_{E} is a width of the vehicle, aₗₐₜ is a lateral acceleration of the vehicle, and V_{E} is a current speed of the vehicle.

13. An apparatus comprising:
memory storing instructions; and
at least one processor,
wherein the at least one processor is configured to execute the instructions to cause the apparatus to:
identify, via one or more sensors, a plurality of objects around a vehicle;
determine, among the plurality of identified objects and based on a distance between the vehicle and each of the plurality of identified objects, a plurality of target objects that are at risk of colliding with the vehicle;
determine, based on classifying a location of each of the plurality of target objects into one of a plurality of subregions within a driving lane of the vehicle, a vehicle control path for the vehicle; and
control, based on the vehicle control path, the vehicle to avoid colliding with the plurality of target objects.

14. The apparatus of claim 13, wherein the plurality of subregions comprise at least a left subregion, a right subregion, and a center subregion.

15. The apparatus of claim 14, wherein the at least one processor is configured to execute the instructions to control the vehicle by:
based on at least one of the plurality of target objects being present in the center subregion, moving a brake control timing of the vehicle from a first time to a second time that is earlier than the first time.

16. The apparatus of claim 14, wherein the at least one processor is configured to execute the instructions to control the vehicle by:
based on none of the plurality of target objects being present in the center subregion and at least some of the plurality of target objects being present in the left subregion and in the right subregion, controlling steering of the vehicle to avoid colliding with the plurality of target objects.

17. The apparatus of claim 14, wherein the at least one processor is configured to execute the instructions to control the vehicle by:
based on none of the plurality of target objects being present in the center subregion and at least one of the plurality of target objects being present in one of the left subregion or the right subregion, operating a braking function of the vehicle.

18. A computer-readable storage medium storing instructions that, when executed by at least one processor, cause:
identifying, via one or more sensors, a plurality of objects around a vehicle;
determining, among the plurality of identified objects and based on a distance between the vehicle and each of the plurality of identified objects, a plurality of target objects that are at risk of colliding with the vehicle;
determining, based on classifying a location of each of the plurality of target objects into one of a plurality of subregions within a driving lane of the vehicle, a vehicle control path for the vehicle; and
controlling, based on the vehicle control path, the vehicle to avoid colliding with the plurality of target objects.

19. The computer-readable storage medium of claim 18, wherein the plurality of subregions comprise at least a left subregion, a right subregion, and a center subregion.

20. The computer-readable storage medium of claim 19, wherein the instructions, when executed by at least one processor, cause the classifying of the location by at least one of:
determining, based on a distance between a left line of the driving lane and a target object, of the plurality of target objects, being less than a width of the left subregion, that the target object is present in the left subregion;
determining, based on a distance between a right line of the driving lane and the target object being less than a width of the right subregion, that the target object is present in the right subregion; or
determining, based on the distance between the left line of the driving lane and the target object being greater than the width of the left subregion and based on the distance between the right line of the driving lane and the target object being greater than the width of the right subregion, that the target object is present in the center subregion.
